(19) United States
(12) Patent Application Publication
(10) Pub. No.: US 2008/0029920 A1
(43) Pub. Date: Feb. 7, 2008

(54) METHOD OF MANUFACTURING A GLIDING BOARD

(75) Inventors: Olivier PERRIN, Passy (FR); Emmanuel Cassibba, Sillingy (FR)

Correspondence Address: BURR & BROWN, PO BOX 7068, SYRACUSE, NY, 13261-7068, US

(73) Assignee: Skis Dynastar, Sallanches (FR)

(21) Appl. No.: 11/828,680

(22) Filed: Jul. 26, 2007

(30) Foreign Application Priority Data
Aug. 3, 2006 (FR) 06.53268

(51) Int. Cl. B29C 67/20

(52) U.S. Cl. 264/46.5

(57) ABSTRACT

This method relates to the manufacture of a gliding board having a non-rectangular cross-section including an upper assembly including at least one upper protective layer and a fibre stiffener impregnated with a thermosetting resin, a polyurethane foam-based core, and a lower assembly including a base of the board. The method involves placing the lower assembly and the upper assembly in a mould, and then injecting a reactive mixture into a space enclosed between the lower assembly and the upper assembly in order to produce an expanded polyurethane foam. The thermosetting resin used to impregnate the fibre stiffener is based on polyurethane and the expanded foam of the core comes into direct contact with the fibre stiffener.

This application claims the benefit under 35 USC § 119(a)-(d) of French Application No. 06.53268, filed Aug. 3, 2006, the entirety of which is incorporated herein by reference.

### FIELD OF THE INVENTION

The present invention relates to the field of manufacturing snow gliding boards. It refers more especially to boards produced using an injection process making it possible to produce a core made of foam, typically polyurethane foam. It refers more specifically to the use of special textile stiffeners suitable for injection processes.

### BACKGROUND OF THE INVENTION

Generally speaking, gliding boards of the ski, surfboard and other types are designed to have optimal mass and stiffness obtained using manufacturing methods that are as simple as possible.

To give a board the required stiffness, it is common to use a combination of mechanical stiffeners of various types, in particular resin impregnated textiles. These textile stiffeners are in the form of fibre mats, especially mats of glass fibres or other woven or non-woven unidirectional or bidirectional fibres depending on the mechanical characteristics which are to be conferred to the board. These stiffeners are impregnated with resin made of a thermosetting or thermoplastic material so that they contribute to the overall rigidity of the board.

Impregnated textile stiffeners are widely used and are usually impregnated with a thermosetting resin of the epoxy resin type which is chosen because it penetrates deep into the fibres of the stiffener and, above all, because of its high rigidifying power.

Besides methods involving moulding on a preformed core made of wood or synthetic foam, methods involving so-called in situ injection to which the present invention relates also deserve mention.

In fact, of the known methods, the simplest method involves producing an upper assembly, i.e. an assembly which includes a decorative and protective layer associated with a stiffening fibre layer.

This fibre layer is impregnated with an epoxy type thermosetting resin. This upper assembly is independently shaped in a mould and the latter is exposed to a source of heat so as to cause polymerisation of the resin of the stiffener.

Once this upper shell has been produced, polyurethane foam is then injected into the space underneath the shell and on top of a lower assembly previously placed in the mould.

Because the resin of the stiffener is previously polymerised, when the polyurethane foam comes into contact with it this creates an interface where adhesion is poor or even non-existent. With this type of method, it is therefore necessary to perform prior sanding of the lower face of the stiffener after polymerisation in order to form adhesion areas.

Other methods have been suggested in order to mitigate these drawbacks by using fibre stiffeners, the resin of which is not fully polymerised and which therefore polymerises during the reaction to form the polyurethane foam of the core.

In this case, the upper assembly is placed in a mould with a stiffener which is impregnated with resin which is not in a fully polymerised state. If the resin is in an almost untreated state, i.e. still sticky or “tacky”, it sticks naturally to the lower face of the upper protective layer. Otherwise or if the reinforcing resin has been slightly heated, it changes to a so-called “non-tacky” state which makes it easier to handle.

Such a method is described, in particular, in European Patent Application Publication No. 0 306 418 A1. Nevertheless, this method is not entirely satisfactory in as much there are parasitic chemical reactions between the components of the polyurethane foam and the components of the epoxy resin. These parasitic reactions result in areas where attachment of the resin and the polyurethane foam cannot be ensured and these areas are fragile and prone to structural delamination because the various components of the board are not properly bonded.

This is why several solutions have been suggested in order to obtain a leaktight seal between the epoxy resin of the stiffener and the polyurethane foam of the core. French Application Publication No. 2 626 521 A1 proposes interposing a sheet of absorbent paper between the stiffener and the resin in order to prevent the polyurethane foam and the epoxy resin penetrating into each other.

Another solution described in European Patent Application Publication No. 0 861 681 A1 suggests interposing a layer of a non-woven material having a calibrated porosity between the resin and the foam. This way the polyurethane foam penetrates only partially into this intermediate non-woven layer and does not come into contact with the epoxy resin which itself penetrates partially into the other side of this non-woven layer. It is apparent that one of the difficulties with this solution is how to precisely determine the porosity of the non-woven layer, this phenomenon being difficult to control homogeneously over the entire length of the board.

Another solution is described in French Application Publication No. 2 854 645 A1. This involves inserting a leakproof plastic sleeve between the lower and upper assemblies and injecting the components of the polyurethane foam, which is designed to expand, into this sleeve. This sleeve ensures a leaktight seal between the epoxy-resin impregnated fibre-stiffener element and the polyurethane foam. Unfortunately, such a solution has certain disadvantages. The plastic sleeve is stretched when the foam expands and in practice this results in random deformation of the sleeve and, consequently, inaccurate positioning of the internal elements in the structure of the ski. Besides this, the presence of a layer of elastomer materials produces damping phenomena inside the board which affect the general behaviour of the board.

### SUMMARY OF THE INVENTION

The invention therefore relates to a method of manufacturing a gliding board having a non-rectangular cross-section.

Such a gliding board conventionally comprises an upper assembly including at least one upper protective layer and a fibre stiffener impregnated with a thermosetting resin; a polyurethane foam-based core; and a lower assembly including the base of the board.

Conventionally, one manufacturing method consists of a sequence of several stages in which the lower and upper assemblies are first placed in a mould with the resin used to impregnate the fibre stiffener of the upper assembly being in a non-polymerised state. Then one injects a reactive mixture into the space enclosed between the lower and upper assemblies in order to produce an expanded polyurethane foam.

According to the invention, the thermosetting resin used to impregnate the fibre stiffener is based on polyurethane and the expanded foam of the core comes into direct contact with the stiffener.

In other words, in contrast to the prior art, the invention involves using a resin which is chemically more compatible with the reactive components used to produce the polyurethane foam of the core. In other words, the resin used to impregnate the stiffener is of the same type as the resin that constitutes the core. This being so, problems due to parasitic chemical reactions are eliminated. Although the mechanical properties of polyurethane resins are slightly inferior to those of epoxy resins, experience shows that one can easily manage to produce gliding boards having totally acceptable mechanical properties. The method according to the invention is nevertheless significantly advantageous in as much as it is not necessary to use a leaktight interface between the core and the stiffener and, above all, because bonding takes place between the resin of the stiffener and that of the core. In fact, slight penetration of the foam of the core into the stiffener has been observed. This way, the stiffener is securely anchored to the core without too many parasitic phenomena at the level of the interface with the resin which impregnates it.

In addition, in comparison with conventional methods which use epoxy resin, the method according to the invention makes it possible to reduce the polymerisation time and the actual temperature is also lower, varying from 80 to 120° C. and preferably being approximately 105° C.

In practice, the resin of the stiffener can be in a tacky state or a non-tacky state when the upper assembly is placed in the mould, depending whether the intention is to give preference to interpenetration of the resins or ease of handling.

Obviously, the invention also covers variations whereby the lower assembly includes one or more fibre stiffeners which is/are also impregnated with a polyurethane-based thermosetting resin.

According to another aspect of the invention, the method may use a prior stage to produce the stiffener of the upper assembly in which fibre stiffeners are placed on a film, typically a polyethylene-based film, the fibre stiffener is impregnated with a polyurethane-based thermosetting resin; and the stiffener is covered with a second film, then one presses the stiffener covered in these two films in order to even out the distribution of the resin in the reinforcing layer.

If applicable, one can consequently expose the stiffener, thus protected, to a source of heat with a view to making it non tacky.

Next, regardless whether or not the stiffener was heated, one film is removed so as to apply the exposed face of the stiffener against the upper protective layer.

The other film is then removed before the upper assembly is placed in the mould.

Advantageously and in practice, in order to facilitate polymerisation reactions, one can expose the entire mould to a heat source during the polymerisation reaction of the mixture that constitutes the core.

### BRIEF DESCRIPTION OF THE DRAWINGS

In order that the way in which the invention is implemented and its resulting advantages may more readily be understood, the following description is given, merely by way of example, reference being made to the accompanying drawings:

FIG. 1 is a schematic perspective view of a fibre stiffener shown during the stage when it is impregnated with resin;

FIG. 2 is a cross-sectional view of a mould into which the lower and upper assemblies have been placed; and

FIG. 3 is a cross-sectional view of the same mould shown after injection of the polyurethane foam.

### DETAILED DESCRIPTION OF THE INVENTION

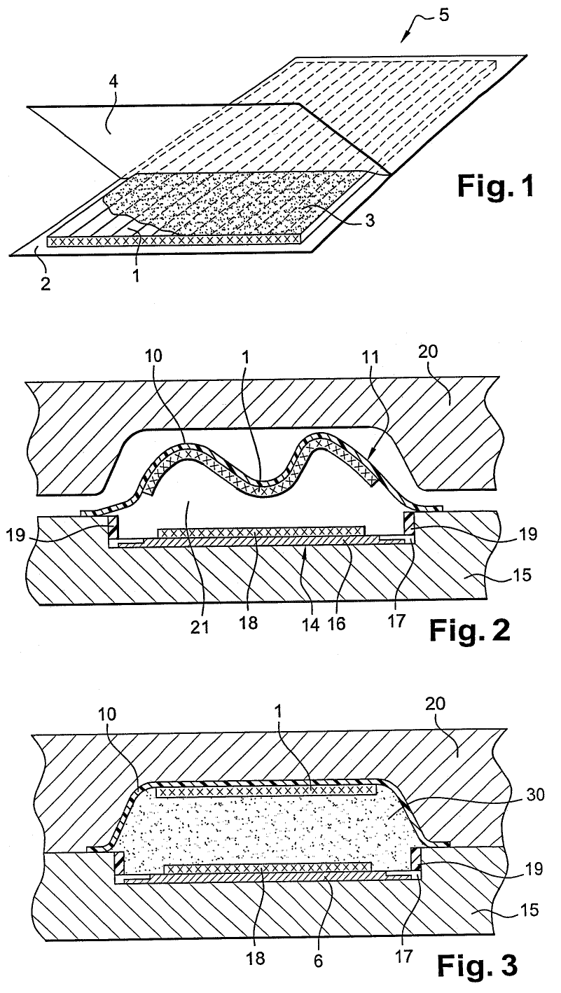

The method according to the invention comprises a first stage involving impregnating a fibre stiffener with a polyurethane-based thermosetting resin. In this stage, as shown in FIG. 1, stiffener (1) is initially placed on film (2) which is typically polyethylene-based. The stiffener is then impregnated with a polyurethane-based resin using a brush application technique or similar. The formulation of this resin can vary widely as long as it includes polymerising chemical reagents in polyurethane form as its primary constituent. By way of example, the resin marketed under the BAYPREG brand name by BAYER MATERIEL SCIENCE AG is satisfactory. When this resin is deposited on fibre stiffener (1), a second film (4), also made of polyethylene, is applied to the exposed face of the stiffener. Assembly (5) thus formed is subjected to pressure in order to ensure uniform impregnation of the resin over the entire surface area of the stiffener.

By way of example, the stiffeners used can be unidirectional stiffeners, i.e. mats of yarns having a very large size in the longitudinal direction of the board. These mats of yarns can be associated either by weaving using very small-diameter thread or by using classic stitching operations.

As appropriate, assembly (5) formed by stiffener (1) sandwiched between films (2) and (4) can be exposed to a source of heat so as to complete a first partial polymerisation stage leaving this resin in a condition conventionally referred to as stage B or Beta stage. However, it is not necessary to perform this partial polymerisation in order to implement the invention.

The fibres of the fibre stiffener are either natural or synthetic, for example fibres made of carbon, glass, polyaramide (Kevlar®), or even a blend of these fibres.

Subsequently, stiffener (1) is associated with upper protective layer (10). To achieve this, film (4) is peeled off so that the stiffener has an exposed face which can be applied onto the lower face of upper protective layer (10). If the resin has not been heated, it remains in a sufficiently tacky state to stick to upper protective layer (10) immediately. Conversely, if the resin used to impregnate the stiffener is in a non-tacky state, a bonding intermediate is used to attach stiffener (10) to upper protective layer (10).

Then, the bottom of mould (15) receives the lower assembly, shaped in the form shown, of the smooth base (16) bordered by edges (17) and topped by another fibre stiffener layer (18). Longitudinal reinforcing elements (19) are also introduced in order to form the lateral edges of the future board. Upper assembly (11) consisting of upper protective layer (10) and stiffener (1) is then placed on top of the open space of the mould. The mould is then closed by its cover (20).

The undulating shape of upper assembly (10) and (11) defines, between this upper assembly and the lower assembly, a space (21) into which the components which react in order to form the polyurethane foam will be injected and spread.

After injection and as shown in FIG. 3, these components react and expand, thereby pushing upper assembly (11) against cover (20) of the mould, thus giving the gliding board its final shape. The pressure exerted by the foam of the core results in the foam penetrating slightly into stiffener (1) thus ensuring effective anchoring of the stiffener to the core. The chemical compatibility of the resin of the core and that of the stiffener means that there is chemical continuity between the core and the stiffener and this increases the rigidity of the assembly.

In the embodiment described, stiffener (1) may not extend laterally as far as edges (19). However, in a variation which is not shown, not only said fibre stiffener may reach as far as edges (19), the latter may be retracted in order to create a shell structure with said stiffener then extending as far as edges (17).

At the same time, lower stiffener (18) may also extend as far as lateral edges (19) or even, if there are no lateral edges, extend onto edges (17).

The upper assembly used can be more complex. In particular, it may consist of a combination of reinforcing elements such as a metal plate, a fibre stiffener element impregnated with a previously polymerised thermosetting resin and/or a fibre stiffener element impregnated with a thermoplastic resin or, obviously, the resin according to the invention.

The foregoing description shows that the method according to the invention has the advantage of allowing the manufacture of gliding boards using a method which is simple because it does not include any leaktight intermediate but confers especially attractive rigidity properties.

1. A method of manufacturing a gliding board having a non-rectangular cross-section comprising:
an upper assembly including at least one upper protective layer and a fibre stiffener impregnated with a thermosetting resin;
a polyurethane foam-based core; and
a lower assembly including a base of the board, wherein:
one places the lower assembly and the upper assembly, in which the resin used to impregnate said fibre stiffener is not in a fully polymerised state, are placed in a mould;
and then one injects a reactive mixture is injected into a space enclosed between the lower assembly and the upper assembly in order to produce an expanded polyurethane foam;
wherein the thermosetting resin used to impregnate the fibre stiffener is based on polyurethane, and the expanded foam of the core comes into direct contact with said fibre stiffener.

2. A method of manufacturing a gliding board as claimed according to claim 1, wherein the thermosetting resin of the fibre stiffener is in a tacky state when the upper assembly is placed in the mould.

3. A method of manufacturing a gliding board as claimed according to claim 1, wherein the thermosetting resin of the fibre stiffener is in a non-tacky state when the upper assembly is placed in the mould.

4. A method of manufacturing a gliding board according to claim 1, wherein the upper assembly consists of a combination of reinforcing elements including at least two of a metal plate, a fibre reinforcing element impregnated with a previously polymerised thermosetting resin, and a fibre reinforcing element impregnated with a thermoplastic resin.

5. A method of manufacturing a gliding board according to claim 1, wherein the lower assembly includes a fibre stiffener impregnated with a polyurethane thermosetting resin.

6. A method of manufacturing a gliding board according to claim 1, comprising a prior stage of producing the fibre stiffener of the upper assembly in which:
the fibre stiffener is placed on a film, typically a polyethylene-based film,
the fibre stiffener is impregnated with a polyurethane-based resin;
the fibre stiffener is covered with a second film; and
the fibre stiffener covered with the films is pressed in order to even out the distribution of the thermosetting resin in the fibre stiffener.

7. A method of manufacturing a gliding board according to claim 1, wherein the fibre stiffener is exposed to a source of heat in order to make it non-tacky.

8. A method of manufacturing a gliding board according to claim 1, wherein the mould is exposed to a source of heat during a polymerisation reaction of the mixture that constitutes the core.
